(19) United States
(12) Patent Application Publication
(10) Pub. No.: US 2010/0154700 A1
(43) Pub. Date: Jun. 24, 2010

(54) Instrument Gauge And Pointer

(75) Inventors: Dale O. Cramer, Royal Oak, MI (US); Stephen Lee Betts, Canton, MI (US); Pascal Guirauton, Houilles (FR)

Correspondence Address: DICKINSON WRIGHT PLLC, 1875 Eye Street, NW, Suite 1200, WASHINGTON, DC, 20006, US

(73) Assignee: VISTEON GLOBAL TECHNOLOGIES, INC., Van Buren Township, MI (US)

(21) Appl. No.: 12/341,321

(22) Filed: Dec. 22, 2008

(51) Int. Cl. G01D 11/28

(52) U.S. Cl. 116/288

(57) ABSTRACT

A pointer for an instrument panel having an enlarged central display area substantially free from obstruction from the pointer as it rotates about an axis located within the central display area.

### BACKGROUND OF THE INVENTION

1. Technical Field

This present invention is directed to an instrument gauge and pointer and more specifically, to an instrument gauge and pointer having an enlarged central display area substantially free from obstruction by the pointer as it rotates about an axis located within the central display area.

2. Discussion

Vehicle manufactures continually strive to differentiate vehicles in the marketplace, through unique styling and aesthetic features as well as through unique and increased functionality. As part of this differentiation, many manufacturers specifically strive to provide a unique look and feel in the instrument panels and gauges that interact with the operator of the vehicle. More specifically, each manufacturer strives to differentiate their vehicles with consumers by providing aesthetically different instruments panels, generally through unique colors, gauge placements and indicia designs. This has allowed manufacturers only limited differentiation and therefore, vehicle manufacturers and designers desire increase differentiation between instrument panels and gauges.

As vehicles add functionality and additional electronic devices and sensors, many manufacturers have been constrained by the limited display space in the gaze-forward position. Manufacturers and designers strive to maximize the amount of information that may be clearly communicated to the vehicle operator in the gaze-forward position. The gaze-forward position generally refers to the area approximately in view of the operator as they gaze through the windshield in the direction of travel. Traditionally, the instrument cluster substantially behind the steering wheel is in the gaze-forward position. Therefore, manufacturers and designers desire to clearly communicate without confusion, as much information as possible in this limited display area.

Almost all gauges, whether as independent gauges or gauges within an instrument panel or cluster, include a pointer that is mounted on a pin or shaft that extends through the central display of the gauge. The pointer generally rotates about an axis of a shaft to point to various indicia and communicate information the vehicle operator. As the pointer may be generally located at any radial point, the central display area across which the pointer sweeps allows for only limited, unobstructed functionality. For example, if a status light is placed in the central display area, it may be at times obstructed by the pointer and have limited visibility to the operator. This limits the use and functionality of the central display areas under the pointer which forms a predominant amount of display space in the gaze-forward position. In turn, this limits the available display area in the gaze-forward position and the design options available to vehicle manufacturers to communicate additional information and provide additional functionality in the gaze-forward position.

Recently, one manufacturer eliminated the shaft extending through the central display surface, to allow the use of the area in the central display surface. These gauges included a frusto-conical shaped display surface, on which the indicia is located. The surface, when combined with a radial display housing allows the vehicle operator to see the gap through which the pointer extends, and depending on the viewing angle, this gap may by substantial. As many gauges are backlit, in some instances, these gaps may allow light leakage that may be distracting or annoying to the vehicle operator at night. Therefore, it is desirable to minimize these gaps and substantially eliminate them from the view of the operator.

The pointers in these gauges without the shaft extending through the central display area are difficult to uniformly and brightly illuminate such that they are visible in most lighting conditions. Therefore, there is a need for an improved lit pointer.

### SUMMARY OF THE INVENTION

In view of the above, the present invention is directed to a pointer for an instrument panel and an instrument gauge having an enlarged central display area substantially free from obstruction by the pointer as it rotates about an axis located within the central display area. The present invention generally includes an instrument gauge having a housing including a housing tube, a backplate within the housing and having curved radial portion. The housing tube and the curved radial portion define a pointer space and a pointer extends through the pointer space and at least partially overlaying said curved radial portion. The pointer assembly may include a shaft portion including an axis of rotation, a first extending portion extending radially outward from the axis of rotation, and a first curved portion extending both radially outward from the axis and culminating in a portion extending approximately along the axis. From the first curved portion, a radially inward extending portion extends radially inward and a second curved portion extends radially inward and at least partially toward the first extending portion.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a perspective view of an exemplary gauge and an exemplary pointer;

FIG. 2 is a front elevational view of the exemplary gauge and pointer without the housing tube;

FIG. 3 is a side elevational view of the exemplary instrument gauge and pointer;

FIG. 4 is a sectional view of the exemplary instrument gauge and pointer;

FIG. 5 is a top view of the exemplary instrument gauge and pointer;

FIG. 6 is a an exploded perspective view of the pointer; and

FIG. 7 is a perspective view of an exemplary lit pointer.

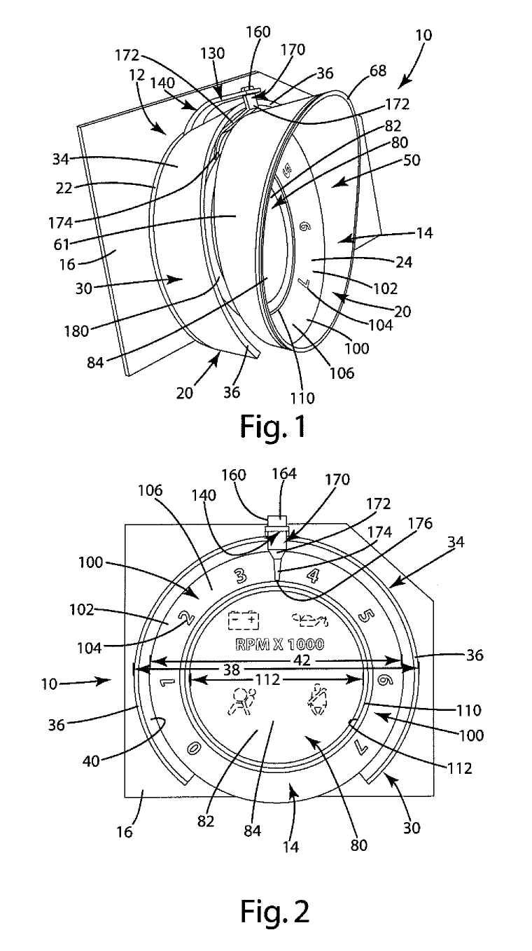

### DETAILED DESCRIPTION OF THE PREFERRED EMBODIMENT

The present invention is directed to a gauge 10 that may be used independently as a single gauge or as part of an instrument panel (not illustrated) or an instrument cluster (not illustrated). In the Figures, the gauge 10 is illustrated with minimal components and although not illustrated, various additional housing or other design features may be added for functional as well as aesthetic and styling purposes.

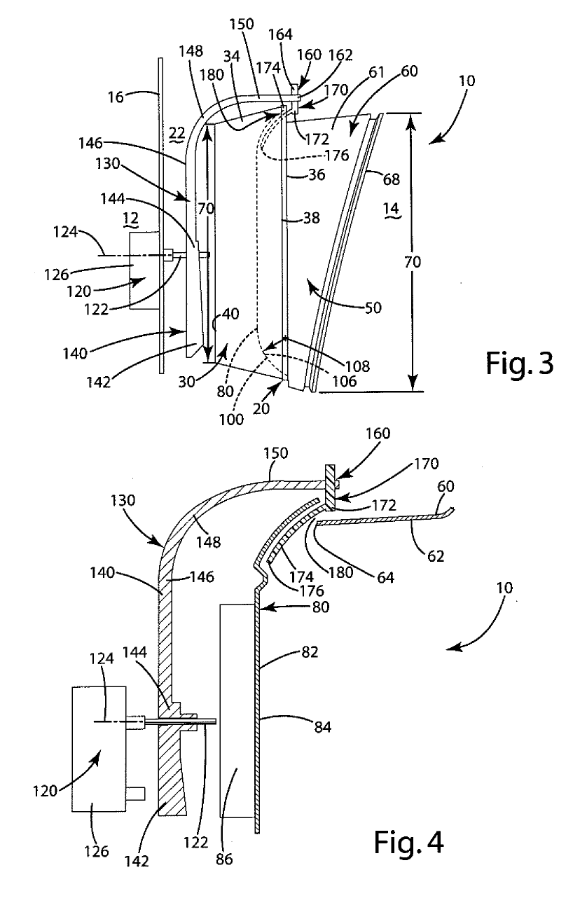

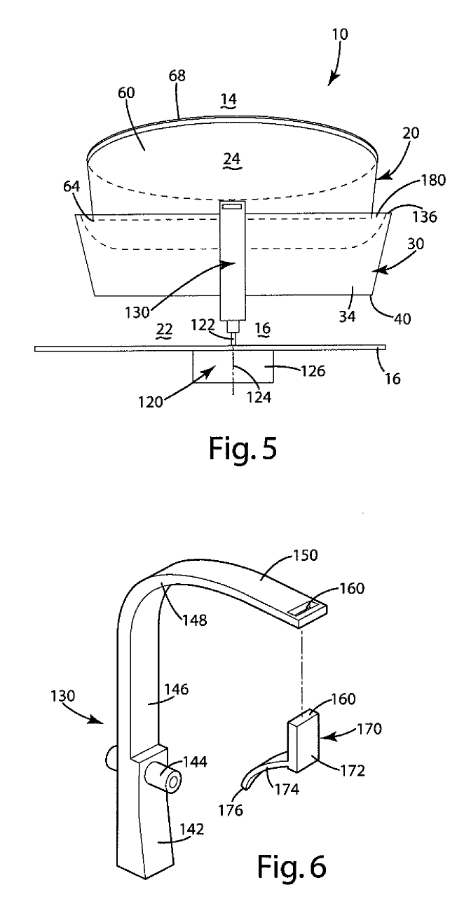

The gauge 10 generally has a display side 14 and an opposing functional side 12 that allows for various mechanical and electrical components to be hidden from view by the operator. For example, on the functional side 12, a drive unit 126 may be included to rotationally drive the pointer assembly 130 radially about the gauge 10. As further illustrated in FIG. 3, the functional side 12 may also include various structural supports 16 to support the gauge in a desired position.

The gauge 10 generally includes a housing 20, having a rear housing assembly 30 and a front housing assembly 50. The gauge 10 further includes a housing tube 60 as part of the front housing assembly 50 and a backplate 80. A pointer assembly 130 communicates the desired information to the operator of the vehicle. All of the components may be formed with various styling, aesthetic and functional characteristics that are different than the illustrated embodiments.

The housing 20 may be formed in a variety of styles and designs and generally defines a cavity 22 on the functional side 12 and a display cavity 24 on the display side 14. The cavity 22 generally provides space to house various mechanical and electronic components. The display cavity 24 is generally the cavity visible to the operator behind a transparent pane (not illustrated).

The housing 20 generally includes a rear housing assembly 30 and a front housing assembly 50. The rear housing assembly 30 is generally illustrated in the Figures as having a can 34 for retaining the backplate 80 in position and encasing various components such as the various electronic and mechanical components (not illustrated). The can 34 is generally formed in a frusto-conical shape with the forward edge 36 having a forward diameter 38 that is larger than the rear diameter 42 at the rearward edge 40. Of course in some embodiments (not illustrated), the housing may be formed without the can 34 and the backplate 80 may be attached directly to a structural member 16, or the backplate 80 may be integrally formed with the can 34 (not illustrated).

The front housing assembly 50 generally includes a housing tube 60 that forms a portion of the display side 14. The housing tube 60 generally includes an inner surface 62 and an outer surface 61. The housing tube 60 further includes an inner edge 64 and an outer edge 68.

The inner edge 64 is in closer proximity to the display surface 82 of the backplate 80 than the outer edge 68. The housing tube 60 also has a frusto-conical shape, although other shapes and styles may be used, so long as the inner edge 64 has an inner edge diameter 66 that is smaller than the outer edge diameter 70 of the outer edge 68. The housing tube 60, although illustrated as being somewhat cylindrical, may be formed in a variety of other shapes and styles, such as the inner and outer edges 64, 68 not forming a full circumference. For example, in forming a central gauge, the bottom portion of the gauge may be eliminated such that a larger radius of pointer assembly may be used to display such as an RPM or speedometer gauge than would be available if the housing extended in a perfect cylindrical shape. The housing tube 60 may also be used to secure the transparent plate (not illustrated) in place in particular for an independent gauge (not illustrated).

The backplate 80 generally forms the display surface 82 visible to the operator and including various indicia 104. The backplate 80 may also locate or include various electronic devices or status signals, particularly in the central display area 84. The central display area 84 is typically the area confined inside of the indicia 104, and within the area through which the pointer would traditionally sweep. As the central display area 84 in the present invention is free of the pointer assembly 130, many new designs and styles are well as new methods to communicate information, which were previously not available.

As illustrated in the Figures, the backplate 80 includes any appliqué 100 coupled to the display surface 82. Of course, the appliqué 100 may be integrally formed with the display surface 82. As illustrated in the Figures, the indicia 104 may be applied to the appliqué 100, specifically to the appliqué surface 102. The appliqué 100 or if the appliqué is integrally formed to the backplate 80, has a curved outer proximity 106 which forms a portion of the display surface. This curved outer proximity 106 includes a radius 108 and extends around the outer perimeter of the backplate 80. The curved outer proximity generally includes a central edge from which the radius starts or as illustrated in the Figures, when an appliqué is applied, the center edge 110 of the appliqué having a central edge diameter 112. The curved outer proximity 106 extends from the center edge 110 to an outer edge 114. The outer edge 114 includes an outer edge diameter 116 having a diameter greater than the inner edge diameter or center edge diameter 112. It is important that the outer edge diameter 116 of the outer edge 114 is greater than the inner edge diameter 66 of the inner edge 64 of the housing tube 60. Therefore, by using the curved appliqué surface instead of a flat or frusto-conical appliqué surface on which the indicia 104 is located, the gauge 10 appears to have a gapless transition between the housing tube 60 and the backplate 80 or the appliqué 100 on the backplate 80 thereby providing a pleasing aesthetic surface as well as improved functionality. The minimized gap 180 between the appliqué 100 or backplate 80 and the housing tube 60 is illustrated in FIGS. 3 and 4.

The gauge 10 may further include a drive assembly 120 for rotating a shaft 122 about an axis 124. The drive assembly typically uses a drive unit 126 to provide the rotational movement to the pointer assembly 130 which is attached to the shaft 122. These drive assemblies 120 are traditionally well known in the art.

The gauge 10 of the present invention also uses a unique pointer to communicate information and point to various indicia 104. The pointer assembly 130 generally includes a hidden member 140 and a forward member 170. The hidden member 140 may be formed as a disk (not illustrated) but is typically formed as a more traditional pointer having a shaft engagement portion 144 that is coupled to the shaft 122 and a first extending portion 146 extending therefrom. A balance portion 142 may be optionally included to be located approximately opposite the first extending portion 146. The hidden member 140 then further includes a curved portion 148 that approximately follows the curve of the backplate 80 and in particular has a curve 1448 that follows the curved outer proximity 106 thereby having a greater radius than radius 108 of the display surface. This curved portion 148 extends from the first extending portion 146 around the curved portion of the backplate 80 to a second extending portion 150. The second extending portion 150 extends away from the drive assembly 120 toward the operator of the vehicle or more specifically, toward the outer edge 68 of the housing tube 60.

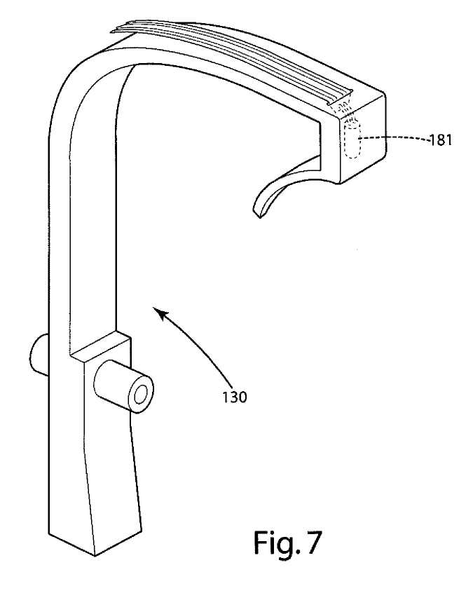

In close proximity to the inner edge 64 of the housing tube 60, the pointer 130 includes a joint 160 that joins the hidden member 140 to the forward member 170. The joint may be any configuration that couples hidden and forward members of the pointer into a complete pointer assembly 130. The pointer assembly 130 is illustrated as having two portions, the hidden member 140, and forward member 170 which are contemplated to provide ease of assembly during the manufacturing process, however, in some embodiments the pointer assembly 130 may be formed of an integral hidden member 140 and forward member 170 without the joint 160, as exemplarily illustrated in FIG. 7. As illustrated in FIG. 6, the hidden member 140 may include a rear joint member 162 that is coupled to a front joint member 164 on the forward member 170. Any desired method of joining the pointer assembly together may be used. Of course, if the pointer assembly 130 is lit from an area near the shaft 122, the type of joint 160 used should be capable of transferring light from the hidden member 140 to the forward member 170 in a seamless fashion, with minimized loss of illumination.

The forward member 170 generally includes a first portion 172 that extends radially inward. Of course, this radially inward extending first portion 172 could be integrally formed on the hidden member 140. From the inward extending first portion 172, a curved inward portion 174 which substantially follows the curved outer proximity 106 with a radius that is smaller than the radius 108 of the curved outer proximity 106 extends inward to a tip 176. A portion of the curved inward portion 174 to the tip 176 is visible to the operator of the vehicle located over the appliqué 100 and is used to point to various indicia. Of course, in some embodiments, the curved portion may extend inward to join to a straight portion which further extends inward toward the tip 176.

In some instrument panels, it may be desirous to provide a brighter lit curved portion 174 and tip 176 than is possible by a pointer that is traditionally lit from around the shaft 122. In these instances, the pointer may be actively lit using a LED 171 that is coupled to the pointer assembly 130 in close proximity to the joint 160.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. An instrument gauge comprising:
a housing including a housing tube;
a backplate within said housing having curved radial portion and wherein said housing tube and said curved radial portion define a pointer space therebetween; and
a pointer extending through said pointer space and at least partially overlaying said curved radial portion.

2. The instrument gauge of claim 1 wherein said backplate includes a central display surface and wherein said curved radial portion extends away from said central display area to terminate in an outer edge and wherein said housing tube includes an includes an inner edge and wherein said pointer space is at least partially defined between said inner edge of said housing tube and said outer edge of said backplate.

3. The instrument gauge of claim 2 wherein said pointer rotates about an axis extending through said central display area and wherein said central display area is substantially free of said pointer.

4. The instrument gauge of claim 2 wherein said pointer rotates about an axis extending though said central display area and wherein said outer edge of said backplate is spaced a first distance in the direction of said axis away from the central display area and wherein said inner edge of said housing assembly area is spaced a second distance in the direction of said axis away from the central display area and wherein said second distance is smaller than said first distance.

5. The instrument gauge of claim 2 wherein said housing tube includes an outer surface and wherein said outer edge of said backplate extends beyond or equal to the inner edge of the housing tube and is spaced a distance from said outer surface of said housing tube.

6. The instrument gauge of claim 1 wherein said housing further includes a can for retaining said backplate.

7. The instrument gauge of claim 1 wherein said backplate includes and appliqué having indicia and said appliqué is curved about a radius.

8. The instrument gauge of claim 1 wherein said pointer includes a display portion and wherein said display portion is curved.

9. The instrument gauge of claim 8 wherein said backplate includes a display surface said pointer is a two portion assembly with a first portion located said on the opposing side of said backplate from said display surface and a second portion at least partially overlaying the display surface.

10. The instrument gauge of claim 9 wherein said central display area includes an LCD display.

11. The instrument gauge of claim 1 wherein said pointer includes a hidden portion and a display portion coupled with a joint.

12. The instrument panel of claim 2 wherein said display portion includes a first portion extending radially inward toward a rotation axis of said pointer and a curved portion that curves along said curved portion of said backplate.

13. The instrument panel of claim 12 wherein said curved portion of said pointer curves radially inward toward said axis and also toward said central display area.

14. The instrument panel of claim 12 wherein said curved portion of said pointer includes a first radius and said curved portion of said backplate includes a second radius and said first radius is smaller than said second radius.

15. The instrument gauge of claim 1 wherein said pointer includes an LED.

16. The instrument gauge of claim 1 wherein said pointer is located both on the display side of said backplate and the opposing side of the backplate.

17. A pointer assembly for an instrument gauge comprising:
a shaft portion including an axis of rotation;
a first extending portion extending radially outward from said axis of rotation;
a first curved portion extending both radially outward from said axis and culminating in a portion extending approximately along said axis;
a radially inward extending portion, said radial inward extending portion extending radially inward from said curved portion;
a second curved portion extending radially inward and at least partially toward said first extending portion.

18. The pointer assembly of claim 17 wherein said instrument gauge further includes a backplate having a curved outer proximity located between said first curved portion and said second curved portion.

19. An instrument gauge comprising:
a housing including a housing tube;
a backplate within said housing having curved radial portion and wherein said housing tube and said curved radial portion define a pointer space therebetween; and
a pointer having radially inward extending curved portion extending through said pointer space and at least partially overlaying said curved radial portion and wherein said pointer includes an axis of rotation a first curved portion extending both radially outward from said axis and culminating in a portion extending approximately along said axis, and a radially inward extending portion, said radial inward extending portion extending radially inward from said curved portion and coupled to said radially inward extending curved portion.
